(19) United States
(12) Patent Application Publication
(10) Pub. No.: US 2009/0306913 A1
(43) Pub. Date: Dec. 10, 2009

(54) METHOD OF CALCULATING ION IMPLANTATION DISTRIBUTION AND PROGRAM IMPLEMENTING THE CALCULATION METHOD

(75) Inventors: Kunihiro Suzuki, Kawasaki (JP); Shuichi Kojima, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/543,965

(22) Filed: Aug. 19, 2009

Related U.S. Application Data
(63) Continuation of application No. PCT/JP2007/053692, filed on Feb. 27, 2007.

(51) Int. Cl. G06F 19/00; G01N 23/00

(52) U.S. Cl. 702/57; 250/281

(57) ABSTRACT

A method of calculating an ion concentration distribution is provided. The method includes: setting meshes at regular intervals d along a beam axis of a beam implanted at a tilt angle α; making mesh intervals on a surface d/sinα; generating meshes parallel and perpendicular to the beam axis in a simulator; and calculating an ion concentration distribution by using the meshes.

### CROSS REFERENCE TO RELATED APPLICATION

This application is a continuation of PCT application PCT/JP2007/053692, which was filed on Feb. 27, 2007, and the entire contents of which are incorporated herein by reference.

### FIELD

The embodiments discussed herein are related to a method of calculating an ion implantation distribution when ions are implanted while giving a tilt, and to a program implementing the calculation method.

### BACKGROUND

These days, the technologies for implanting ions, which are used for manufacturing very large scale integration (VLSI) products, are considered to be very important technologies fundamental to the formation of well regions, the formation of element isolating regions, the formation of junctions, the control of channel impurities for controlling threshold voltage Vth, etc., in processes of manufacturing very large scale integration products.

Ion implantation technologies are the only technologies that may be relied upon to perform accurate control of impurities. When a short channel effect is to be suppressed while increasing the efficiency, the necessity of the formation of shallower junctions and more accurate control of impurity profiles such as more accurate control of channel impurities becomes pressing. Consequently, it is desirable to accurately recognize impurity implantation profiles.

In order to recognize implantation profiles in advance, various types of simulation are conducted. However, it is difficult to directly measure a two-dimensional distribution and extract the parameter of the lateral direction distribution from the measured two-dimensional distribution (hereinafter the directions along and transverse to an ion beam are respectively referred to as longitudinal and lateral directions). Accordingly, a method is proposed. In the proposed method, the parameter of a concentration distribution in the lateral direction in amorphous material is extracted by utilizing the fact that the concentration distribution in a substrate into which ions were implanted at a low tilt angle depends upon the distribution parameter in the lateral direction. Then, in the proposed method, the impurities are controlled accurately using the extracted parameter.

Another method is also proposed in which, when ions are implanted while giving a tilt, the parameter of the concentration distribution in the lateral direction in crystal silicon is extracted to be stored in a database, and the database is used for controlling the impurities accurately.

In the conventional techniques, when ions are implanted while giving a tilt, the concentration distribution in the direction perpendicular to the substrate surface is obtained by adding together the contributions, to a fixed position of the substrate surface, of the individual ions implanted into the respective planes. In other words, the concentration of implanted ions at a certain depth has been obtained by adding together the individual lateral concentration distribution contributions (note that the concentration distribution contribution may be hereinafter referred to simply as contribution) to the ions concerned, i.e., by integrating those lateral contributions while considering the contributions in the lateral direction by the ions implanted into other positions.

Accordingly, it has taken a long time to calculate the concentration distributions at each depth even though the concentration distributions in the depth direction are one dimensional. This reduces the simplicity expected from one dimension. Specifically, in the above-mentioned method, integrations are repeated for individual depths in order to obtain the concentration distribution of ions along the depth in the direction perpendicular to the substrate surface, and this repetition requires a long time.

FIG. 1 is a schematic view explaining a conventional method of calculating the concentration distributions of ions implanted while giving a tilt. In FIG. 1, for a case in which ion beams are implanted into a substrate surface 10 while giving atilt, meshes (i.e., boxes) 30 of arbitrary size are generated. The meshes 30 are defined by virtual lines parallel and perpendicular to the direction of the implantation of the ion beams, and are generated in order to simulate the ion concentration distribution. Then, a point on the mesh 30 at a certain depth in the implanting direction such as point p1 is focused on. The ion concentration distribution at that point p1 is obtained by adding the concentration distribution of the ion beam passing through point p1 in the implanting direction and the ion concentration distributions contributing to point p1 in the direction perpendicular to the implanting direction.

In other words, when the concentration distribution at point pl on an ion beam 14 concerned (i.e., at the intersection of a longitudinal line 14 and a lateral line 23) on the mesh 30 at a certain depth from the substrate surface 10 is calculated, the meshes 30 defined in FIG. 1 are generated by a simulator (not illustrated), and are arranged. Then, because the ion concentration distribution in the lateral direction expands one-dimensionally, the concentration distribution at point p1 is calculated by adding the concentration distribution contributions of the ion beams implanted at other points along substantially the same lateral line 23, i.e., the ion beams at points a1, b1, e1, c1, d1, and f1, which are the intersections with longitudinal lines 15, 16, 17, 13, 12, and 11, respectively, in addition to the concentration of point p1 itself.

Similar processes are performed for point q1, and the concentration distribution at point q1 is calculated by adding the concentration distribution contributions of ion beams implanted into other points on a lateral line 25 in addition to the concentration at point q1 itself, which is the intersection of a longitudinal line 15 and a lateral line 25 defining the mesh 30.

Because the ion concentration distributions at all points on the meshes are obtained by adding the concentration of the points themselves and the concentration distributions due to contributions thereto, the calculation of the concentration distributions at all points has required a great deal of time and labor. When the number of the meshes 30 is, for example, 1000×1000, integral calculations need to be performed at 1,000,000 points.

A specific equations to calculate the ion concentration distributions illustrated in FIG. 1 are given below. When the distributions, along a path parallel to the implantation beam direction, of ions implanted with tilt θ are indicated by tail functions nₐ and n_{c}, and the concentration distributions in the lateral directions are indicated by gₐ and g_{c}, the concentration at a depth s on an axis perpendicular to the wafer surface (i.e., substrate surface) is expressed by the analysis coordinate system defined in FIG. 3. The subscript suffix “a” represents an amorphous part, and the subscript suffix “c” represents a channeling part.

The case illustrated in FIG. 2 in which the tilt is zero is discussed before explaining FIG. 3. The distribution of ions implanted into the areas between positions xᵢ and xᵢ+dxᵢ is expressed by the equation (1) below.

### [Equation 1]

dN(x, y)=(Φ−Φ_{chan})n_{α}(y)g_{α}(x−xᵢ, y)dxᵢ+Φ_{chan}n_{c}(y)g_{c}(x−Xᵢ, y)dxᵢ

In the above equation (1), Φ represents the dose amount for the ion implantation, Φ_{chan} chan represents the dose amount in the channeling part, nₐ and n_{c} are the functions expressing the distributions along the depth direction corresponding to the distributions of the amorphous part and the channeling part, respectively, and gₐ and g_{c} are the functions expressing the distributions in the lateral direction corresponding to the distributions of the amorphous part and the channeling part, respectively. It is also supposed that nₐ, n_{c}, gₐ, and g_{c} are normalized. In other words, the equations (2) and (3) below are satisfied.

$$\begin{matrix}{\int }_{- ∞}^{∞} {n}_{a} ( y ) d y = {\int }_{- ∞}^{∞} {n}_{c} ( y ) d y = 1 & [ Equation 2 ] \\ {\int }_{- ∞}^{∞} {g}_{a} ( x - {x}_{i} , y ) d {x}_{i} = {\int }_{- ∞}^{∞} {g}_{c} ( x , {x}_{i} , y ) d {x}_{i} = 1 & [ Equation 3 ]\end{matrix}$$

The concentration N(x,y) is expressed by the sum, along the x direction, of the distributions of the ions implanted at the positions xᵢ, and is thus expressed by the equation (4) below.

$$\begin{matrix}N ( x , y ) = ( Φ - {Φ}_{chan} ) {\int }_{- ∞}^{∞} {n}_{a} ( y ) {g}_{a} ( x - {x}_{i} , y ) d {x}_{i} + \\ {Φ}_{chan} {\int }_{- ∞}^{∞} {n}_{c} ( y ) {g}_{c} ( x - {x}_{i} , y ) d {x}_{i} \\ = ( Φ - {Φ}_{chan} ) {n}_{a} ( y ) {\int }_{- ∞}^{∞} {g}_{a} ( x - {x}_{i} , y ) d {x}_{i} + \\ {Φ}_{chan} {n}_{c} ( y ) {\int }_{- ∞}^{∞} {g}_{c} ( x - {x}_{i} , y ) d {x}_{i} \\ = ( Φ - {Φ}_{chan} ) {n}_{a} ( y ) + {Φ}_{chan} {n}_{c} ( y )\end{matrix} \qquad [ Equation 4 ]$$

Next, the case of giving a tilt θ illustrated in FIG. 3 is discussed. As illustrated in FIG. 3, an (x,y)-plane spanned by x and y axes respectively perpendicular and parallel to the ion beam and a (t,s)-plane spanned by t and s axes respectively parallel and perpendicular to the wafer surface are defined. It is assumed that the ion implantation distribution depends only upon the depth along the beam. According to this assumption, the contribution, to N (x, y), of the distribution of the ions implanted into xᵢ is a contribution to N(x,y) at the depth y+xᵢtanθ. Therefore, the following equation (5) is derived.

$$N ( x , y ) = ( Φ - {Φ}_{chan} ) {\int }_{- \frac{y}{tan θ}}^{∞} {n}_{a} ( y + {x}_{i} tan θ ) {g}_{a} ( x - {x}_{i} , y + {x}_{i} tan θ ) d {x}_{i} + {Φ}_{chan} {\int }_{- \frac{y}{tan θ}}^{∞} {n}_{c} ( y + {x}_{i} tan θ ) {g}_{c} ( x - {x}_{i} , y + {x}_{i} tan θ ) d {x}_{i} \qquad [ Equation 5 ]$$

The concentration distribution based on the SIMS (secondary ion mass spectrometry) evaluates the dependency on s on the (t,s)-plane. Herein, (x,y) and (t,s) are associated with each other in the equations (6a) and (6b) below.

$$\{ \begin{matrix}x = t cos θ + s sin θ \\ y = - t sin θ + s cos θ\end{matrix} \qquad [ Equations 6 a and 6 b ]$$

Substituting equations (6a) and (6b) into equation (5), the following equation (7) is obtained.

$$N ( t , s ) = ( Φ - {Φ}_{chan} ) {\int }_{- \frac{- t sin θ + s cos θ}{tan θ}}^{∞} {n}_{a} ( - t sin θ + s cos θ + {x}_{i} tan θ ) \times {g}_{a} ( t cos θ + s sin θ - {x}_{i} , - t sin θ + s cos θ + {x}_{i} tan θ ) d {x}_{i} + {Φ}_{chan} {\int }_{- \frac{- t sin θ + s cos θ}{t sin θ}}^{∞} {n}_{c} ( - t sin θ + s cos θ + {x}_{i} tan θ ) \times {g}_{c} ( t cos θ + s sin θ - {x}_{i} , - t sin θ + s cos θ + {x}_{i} tan θ ) d {x}_{i} \qquad [ Equation 7 ]$$

N(t,s) is thought not to depend on t. When variable transformation based on the following equation (8) is performed, namely, equation (8) is substituted into equation (7), the following equation (9) is derived.

$$\begin{matrix} k = \frac{- t sin θ + {x}_{i} tan θ}{tan θ} & [ Equation 8 ] \\ N ( s ) = ( Φ - {Φ}_{chan} ) {\int }_{- s \frac{cos θ}{tan θ}}^{∞} {n}_{a} ( s cos θ + k tan θ ) {g}_{a} ( s sin θ - k , s cos θ + k tan θ ) d k + {Φ}_{chan} {\int }_{- s \frac{cos θ}{tan θ}}^{∞} {n}_{c} ( s cos θ + k tan θ ) {g}_{a} ( s sin θ - k , s cos θ + k tan θ ) d k & [ Equation 9 ]\end{matrix}$$

Accordingly, a model formula surely independent of t is obtained.

For each of the lateral distributions gₐ and g_{c}, a normalized Gauss distribution is assumed, and the following equations 10a and 10b are used.

$${g}_{a} ( x , y ) = \frac{1}{\sqrt{2 π} Δ {R}_{pta} ( y )} exp [ - \frac{{x}^{2}}{2 Δ {R}_{pta}^{2} ( y )} ] , \\ {g}_{c} ( x , y ) = \frac{1}{\sqrt{2 π} Δ {R}_{ptc} ( y )} exp [ - \frac{{x}^{2}}{2 Δ {R}_{ptc}^{2} ( y )} ] \qquad [ Equations 10 a and 10 b ]$$

When the lateral standard deviation ΔRₚₜ is made to depend on the depth direction y, and the proportionality coefficient m_{f} at a position shallower than the peak concentration position Rₚ of the implanted ions is supposed to be different from both the proportionality coefficients m_{ba} and m_{bc} at a position deeper than the peak concentration position, the lateral standard deviation ΔRₚₜₐ (y) of the amorphous part and the lateral standard deviation ΔR_{ptc} (y) of the channeling part can be expressed by the equations (11) and (12) below.

$$\begin{matrix}Δ {R}_{pta} ( y ) = \{ \begin{matrix}Δ {R}_{pt 0} + {m}_{f} ( y - {R}_{p} ) for y < {R}_{p} \\ Δ {R}_{pt 0} + {m}_{ba} ( y - {R}_{p} ) for y > {R}_{p}\end{matrix} & [ Equation 11 ] \\ Δ {R}_{ptc} ( y ) = \{ \begin{matrix}Δ {R}_{pt 0} + {m}_{f} ( y - {R}_{p} ) for y < {R}_{p} \\ Δ {R}_{pt 0} + {m}_{bc} ( y - {R}_{p} ) for y > {R}_{p}\end{matrix} & [ Equation 12 ]\end{matrix}$$

### SUMMARY

A method of calculating an ion concentration distribution is provided. The method includes: setting meshes at regular intervals d along a beam axis of a beam implanted at a tilt angle α; making mesh intervals on a surface d/sinα; generating meshes parallel and perpendicular to the beam axis in a simulator; and calculating an ion concentration distribution by using the meshes.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic view explaining a conventional method of calculating the concentration distributions of ions implanted while giving a tilt;

FIG. 2 explains a coordinate system for ion implantation at tilt angle 0 (zero);

FIG. 3 explains coordinate system conversion for ion implantation at tilt angle α;

FIG. 4 illustrates the configuration of meshes used in an embodiment of the invention;

FIG. 5 schematically explains the basis for calculating ion concentration distributions according to an embodiment of the invention;

FIG. 6 schematically explains a method of calculating ion concentration distributions according to an embodiment of the invention;

FIG. 7 is a diagram illustrating a method of calculating ion concentration distributions according to an embodiment of the invention; and

FIGS. 8A to 8C are flowcharts for performing the calculation of ion concentration distributions on the basis of a method of calculating ion concentration distributions according to an embodiment of the invention.

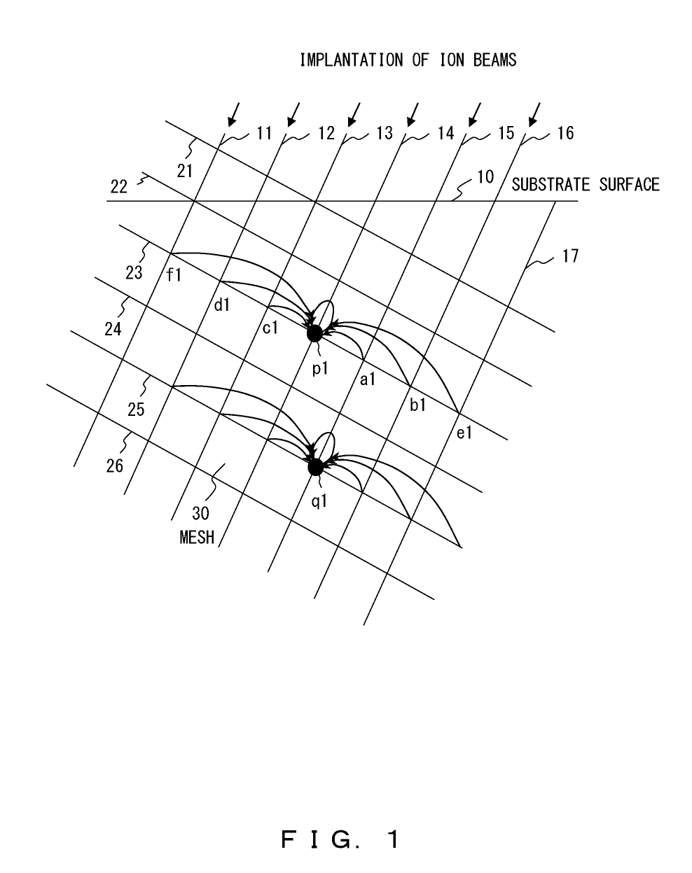

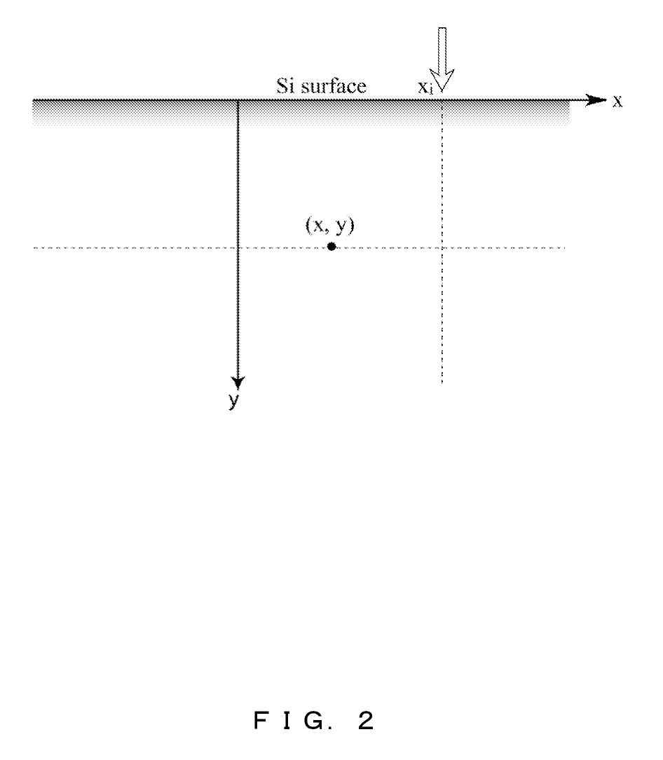

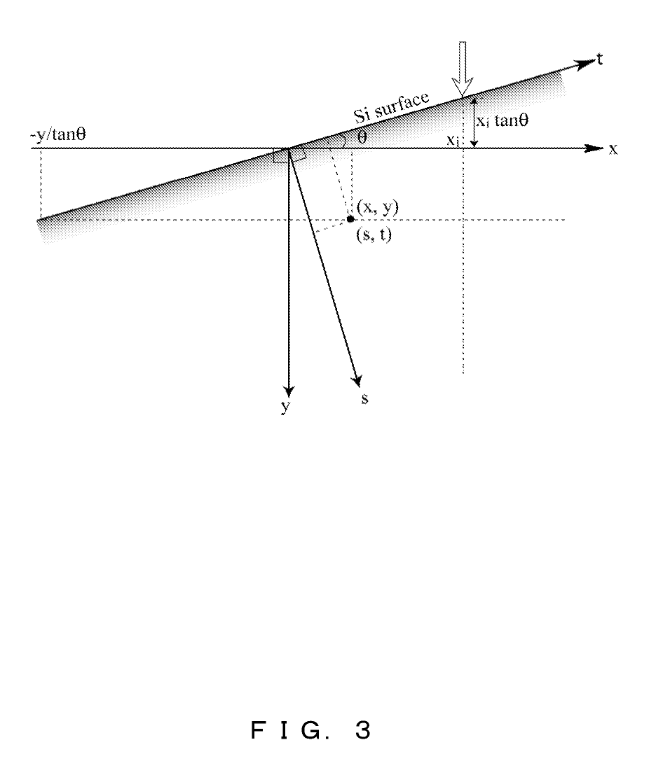

### DESCRIPTION OF EMBODIMENTS

The embodiments of the invention will be explained in detail by referring to drawings.

The following embodiments focus on the fact that the integrations of concentrations of ions at individual depths, the integrations being performed for calculating concentration distributions of ions implanted while giving a tilt, have a common factor. In the embodiments, meshes that simplify the integrations of the ion concentrations at the individual depths are defined for expressing the common factor, and the defined meshes are used for the integrations. In other words, the use of meshes defined by the embodiments makes it possible to substitute the concentration distribution of one focused-on beam for the concentration equivalent to the contribution from another beam different from the one focused-on beam.

Accordingly, when the integration of the ion concentration of individual depth is to be performed, the concentration distribution in the depth direction may be calculated by calculating the information on one linear beam alone, and by adding the information on the two-dimensional distributions of the focused-on one beam in order to calculate a concentration distribution equivalent to the contribution from each beam. Herein, added pieces of the information are those at substantially the same depth as a point concerned whose concentration distribution is to be calculated. As a result, the calculation of ion implantation distributions may be simplified.

The above simplified calculation substantially reduces, by one dimension, the number of dimensions of points for which calculations are to be performed. For example, when the number 1000×1000 of meshes are to be used for performing the integration of an ion concentration at each depth, calculations at 1,000,000 points have been required in the conventional methods, while calculations at only 1,001 points are required in the present embodiment method, which greatly reduces calculation time. The above-noted simplified calculation is described below in detail.

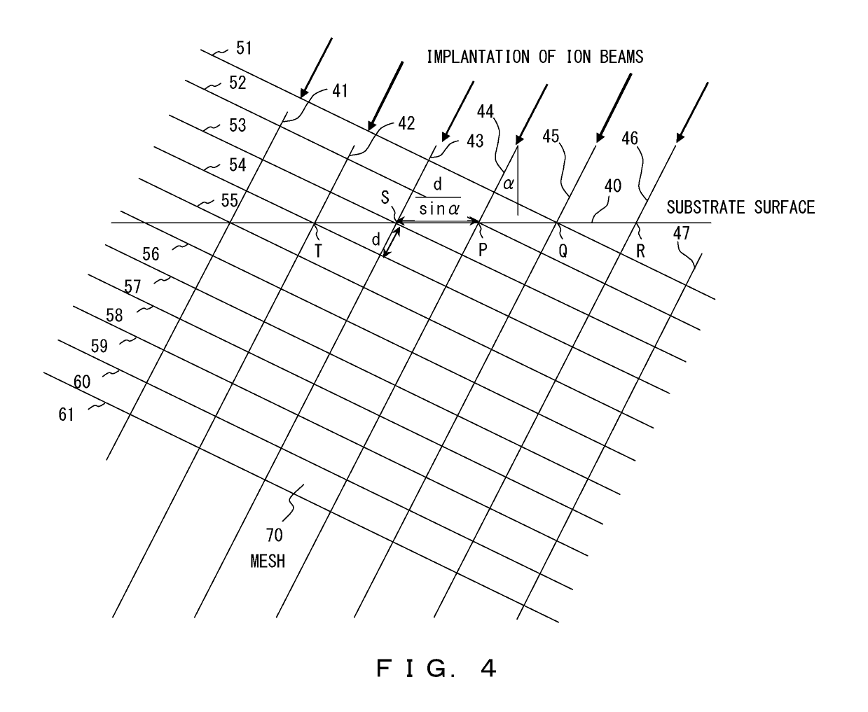

FIG. 4 illustrates the configuration of meshes used in an embodiment of the invention. In FIG. 4, in order to perform a simulation that calculates the ion concentration distribution with beams being implanted at tilt angle α (hereinafter simply referred to as tilt c) into a substrate surface 40, meshes (i.e., boxes) 70 are generated with virtual lines that are parallel and perpendicular to the implanting direction of the beams. The individual meshes 70 are arranged at regular intervals d along an axis of a beam implanted at tilt α, the mesh interval on the substrate surface 40 is set to d/sinα, and thereby the meshes 70 are defined by the virtual lines parallel and perpendicular to the beam axes.

With the meshes 70 defined as above, the beams implanted at tilt angle α (i.e., tilt α) result in the meshes 70 aligned at intervals d/sinα on the substrate surface 40, and the distances between the individual intersections of meshes 70 and substrate surface 40 are equivalent, i.e., d/sinα, with such intersections being referred to as R, Q, P, S, T . . . , starting from the right.

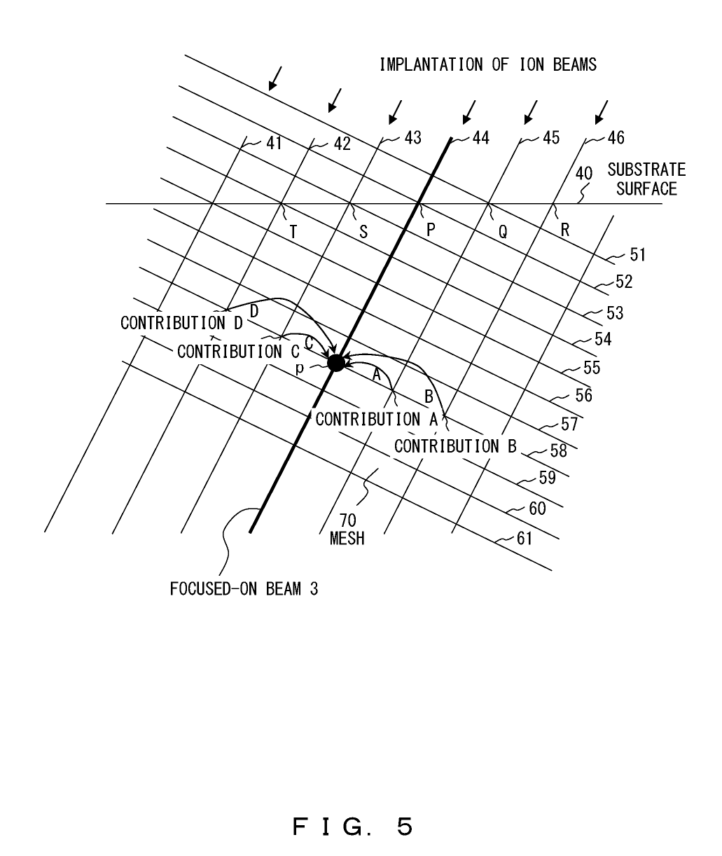

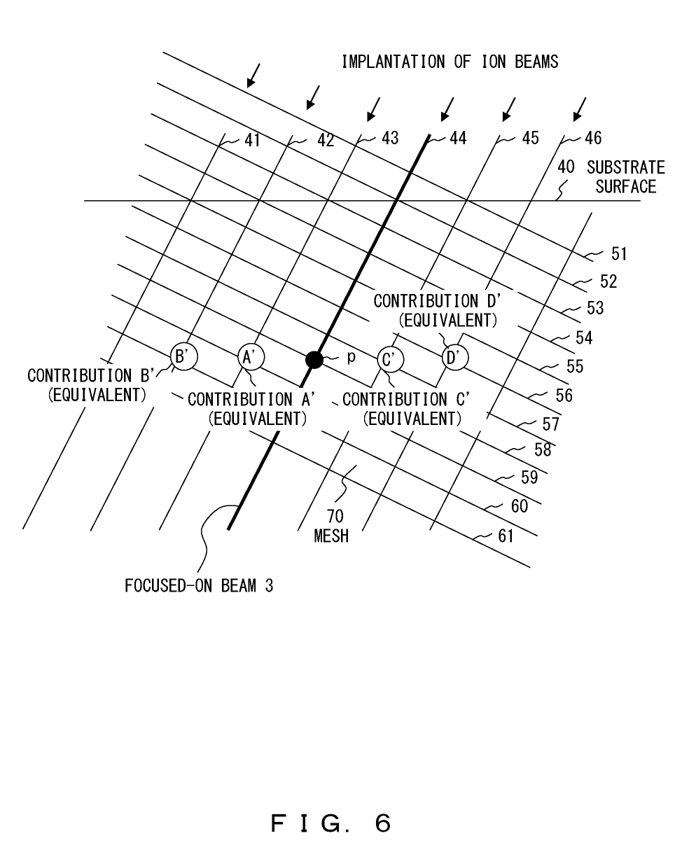

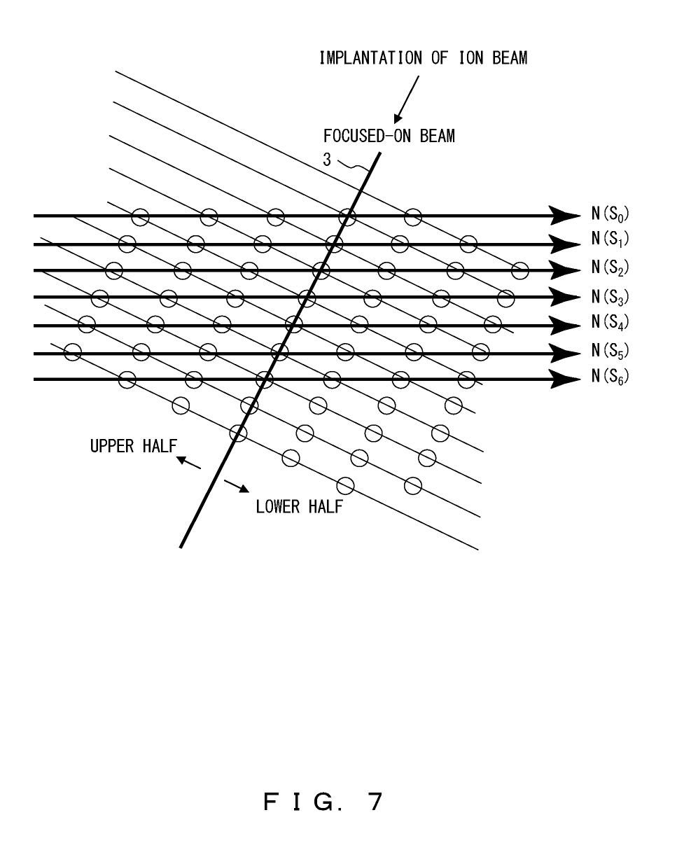

FIG. 5 schematically explains the basis for calculating ion concentration distributions according to an embodiment of the invention. FIG. 6 schematically explains a method of calculating ion concentration distributions according to an embodiment of the invention. FIG. 7 is a diagram illustrating a method of calculating ion concentration distributions according to an embodiment of the invention. In the embodiment, the above meshes are used for ion concentration distribution calculations.

The basis for calculations of ion concentration distributions according to an embodiment of the invention will be explained by referring to FIG. 5. When the concentration distribution of a focused-on ion beam 3 at point p (i.e., intersection of a longitudinal line 44 and a lateral line 58) of the mesh 70 at a certain depth from the substrate surface 40 is to be calculated, the meshes 70 defined in FIG. 4 are generated and arranged in a simulator (not illustrated).

Also, because the ions are implanted while giving a tilt, the two-dimensional distribution in the implanting direction of the beams, i.e., the implantation path direction, is calculated. The calculation of the two-dimensional distributions in the implantation path direction of ion beams is well known in this technical field, and therefore the explanation thereof is omitted.

The concentration distribution at point p in the direction perpendicular to the implantation paths, i.e., in the lateral direction, is calculated from the contributions, by other beams, to point p based on the meshes 70 defined in the embodiment. Specifically, it is calculated by adding together:
contribution A of point A where the lateral line 58, on which point p exists, intersects with a longitudinal line 45 indicating the ion beam implanted to an adjacent point on the right-hand side of point p,
contribution B of point B where the lateral line 58, on which point p exists, intersects with a longitudinal line 46 adjacent to the longitudinal line 45,
contribution C of point C where the lateral line 58, on which point p exists, intersects with a longitudinal line 43 indicating the ion beam implanted to an adjacent point on the left-hand side of point p,
contribution D of point D where the lateral line 58, on which point p exists, intersects with a longitudinal line 42 adjacent to the longitudinal line 43,
. . . etc.

The above description has been given for explaining the basis for calculations of ion distributions in the lateral direction.

However, in the method of simplifying ion concentration distribution calculations in an embodiment of the invention illustrated in FIG. 6, the use of the meshes 70 defined in FIG. 4 is taken into consideration, and contribution A of point A, where the longitudinal line 45 intersects with the lateral line 58 as illustrated in FIG. 5, is replaced in FIG. 6. Specifically, a concentration distribution equivalent to the concentration contribution that is caused by the focused-on beam 3 and that is at a position distant from point p by one mesh in the downward direction and by one mesh in the lateral direction, is substituted for the contribution A of point A; i.e., the concentration distribution due to contribution A′ at point A′ that is the intersection of the longitudinal line 43 and a lateral line 59 is substituted for the contribution A of point A.

To be more specific, contribution A is caused by the beam implanted at point Q on the substrate surface 40 in FIG. 5, and point Q reflects the beam implanted at a position distant from point P by one mesh in the upward direction and by length d/sinα in terms of length of the mesh interval on the substrate surface 40. As FIG. 5 illustrates, point P herein is a point on the substrate surface 40 and the focused-on beam 3 is implanted at point P.

Accordingly, in FIG. 6, contribution A is replaced by a concentration distribution equivalent to a concentration contribution at a certain position at which a lateral path viewed from point p on the focused-on beam 3 has substantially the same length as a lateral path associated with contribution A to point p. Specifically, the certain position is distant from point p by one mesh in the downward direction and by one mesh in the lateral direction. In other words, the concentration distribution due to contribution A′ at point A′, which is the intersection of the longitudinal line 43 and the lateral line 59, is substituted for contribution A.

Contribution B from point B, where the longitudinal line 46 intersects with the lateral line 58 as illustrated in 5 FIG. 5, is replaced in FIG. 6. Specifically, a concentration distribution equivalent to the concentration contribution that is caused by the focused-on beam 3 and that is at a position distant from point p by two meshes in the downward direction and by two meshes in the lateral direction, is substituted for the contribution B of point B; i.e., the concentration distribution due to contribution B′ at point B′ that is the intersection of the longitudinal line 42 and a lateral line 60 is substituted for contribution B of point B.

In other words, in FIG. 5, contribution B is caused by the beam implanted at point R on the substrate surface 40, and point R reflects the beam implanted at a position distant from point P by two meshes in the upward direction and by 2 d/sinα in terms of length of the mesh interval on the substrate surface 40. As FIG. 5 illustrates, point P herein is a point on the substrate surface 40 and the focused-on beam 3 is implanted at point P.

Accordingly, in FIG. 6, contribution B is replaced by a concentration distribution equivalent to a concentration contribution at a certain position at which a lateral path viewed from point p on the focused-on beam 3 has substantially the same length as a lateral path associated with contribution B to point p. Specifically, the certain position is distant from point p by two meshes in the downward direction and by two meshes in the lateral direction. In other words, the concentration distribution due to contribution B′ at point B′, which is the intersection of the longitudinal line 42 and the lateral line 60, is substituted for contribution B.

Contribution C from point C, where the longitudinal line 43 intersects with the lateral line 58 as illustrated in FIG. 5, is replaced in FIG. 6. Specifically, a concentration distribution equivalent to a concentration contribution that is caused by the focused-on beam 3 and that is at a position distant from point p by one mesh in the upward direction and by one mesh in the lateral direction, is substituted for the contribution C of point C; i.e., a concentration distribution due to contribution C′ at point C′ that is the intersection of the longitudinal line 45 and a lateral line 57 is substituted for contribution C of point C.

To be more specific, contribution C in FIG. 5 is caused by the beam implanted at point S on the substrate surface 40, and point S reflects the beam implanted at a position distant from point P by one mesh in the downward direction and by d/sinα in terms of length of the mesh interval on the substrate surface 40. As FIG. 5 illustrates, point P herein is a point on the substrate surface 40 and the focused-on beam 3 is implanted at point P.

Accordingly, in FIG. 6, contribution C is replaced by a concentration distribution equivalent to a concentration contribution at a certain position at which a lateral path viewed from point p on the focused-on beam 3 has substantially the same length as a lateral path associated with contribution C to point p. Specifically, the certain position is distant from point p by one mesh in the upward direction and by one mesh in the lateral direction. In other words, a concentration distribution due to contribution C′ at point C′, which is the intersection of the longitudinal line 45 and the lateral line 57, is substituted for contribution C.

Contribution D from point D, where the longitudinal line 42 intersects with the lateral line 58 as illustrated in FIG. 5, is replaced in FIG. 6. Specifically, a concentration distribution equivalent to a concentration contribution that is caused by the focused-on beam 3 and that is at a position distant from point p by two meshes in the upward direction and by two meshes in the lateral direction, is substituted for the contribution D of point D; i.e., a concentration distribution due to contribution D′ at point D′ that is the intersection of the longitudinal line 46 and a lateral line 56 is substituted for contribution D of point D.

In other words, contribution D in FIG. 5 is caused by the beam implanted at point T on the substrate surface 40, and point T reflects the beam implanted at a position distant from point P by two meshes in the downward direction and by 2 d/sinα in terms of length of the mesh interval on the substrate surface 40. As FIG. 5 illustrates, point P herein is a point on the substrate surface 40 and the focused-on beam 3 is implanted at point P.

Accordingly, in FIG. 6, contribution D is replaced by a concentration distribution equivalent to a concentration contribution at a certain position at which a lateral path viewed from point p on the focused-on beam 3 has substantially the same length as a lateral path associated with contribution D to point p. Specifically, the certain position is distant from point p by two meshes in the upward direction and by two meshes in the lateral direction. In other words, a concentration distribution due to contribution D′ at point D′, which is the intersection of the longitudinal line 46 and the lateral line 56, is substituted for contribution D.

As described above, corresponding to contributions A through D and so on, which contribute to point p in FIG. 5, respective assumed equivalent contributions A′ through D′ and so on are, as illustrated in FIG. 6, positioned on a plane parallel to the substrate surface 40. Accordingly, in calculating ion concentration distributions, all concentration distributions including not only the two-dimensional concentration distribution in the beam direction (i.e., the path direction) of the beam 3 but also the lateral concentration distribution may be calculated by setting the focused-on beam 3 and shifting (i.e., varying) point p along the beam 3.

FIG. 7 is a diagram illustrating a method of calculating ion concentration distributions according to an embodiment of the invention. As illustrated in FIG. 7, the focused-on beam 3 is set, and the ion concentration distributions along the beam 3 are calculated.

In other words, in FIG. 7, the concentration distributions are arranged parallel to the substrate surface 40 at intervals of d/sinα, which is the length defined as the mesh interval, and these concentration distributions are consolidated to be added together so that all the concentration distributions N(S₀) through N(S₆) may be obtained in a simple manner together with the two-dimensional distribution in the direction of the focused-on beam 3. The concentration distributions N(S₀) through N(S₆) in the example are based on one exemplary calculation method and are not intended to limit the scope of the invention.

As described above, according to the embodiment, it is possible to easily perform the ion concentration distribution calculation for ions implanted while giving a tilt by only calculating information on one linear beam for the concentration distribution in the depth direction and by adding together the concentrations at substantially the same depth for each depth.

A calculation method for further simplifying the method of calculating ion concentration distributions according to an embodiment of the invention illustrated in FIG. 7 is explained. When either one of the concentration distributions of the equivalent contributions contributed to points in the upper half of the focused-on beam 3 and the concentration distributions of the equivalent contributions contributed to points in the lower half of the focused-on beam 3 is known, the calculations for the values in the unknown half may be omitted by using the known values because the equivalent contributions on the meshes are line-symmetrical between the upper and lower halves with respect to the focused-on beam 3, and thereby the entire calculation may be simplified further.

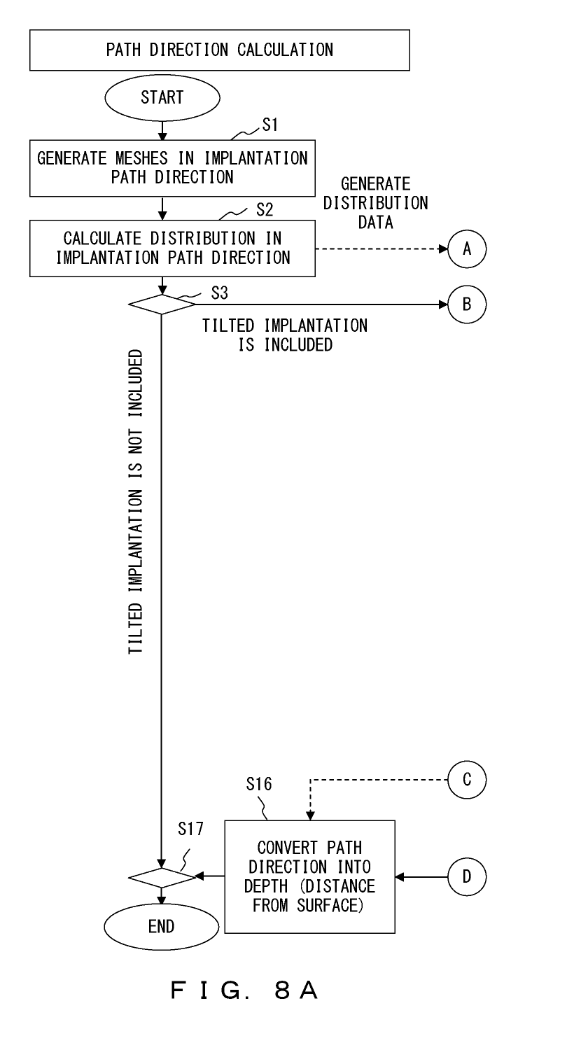

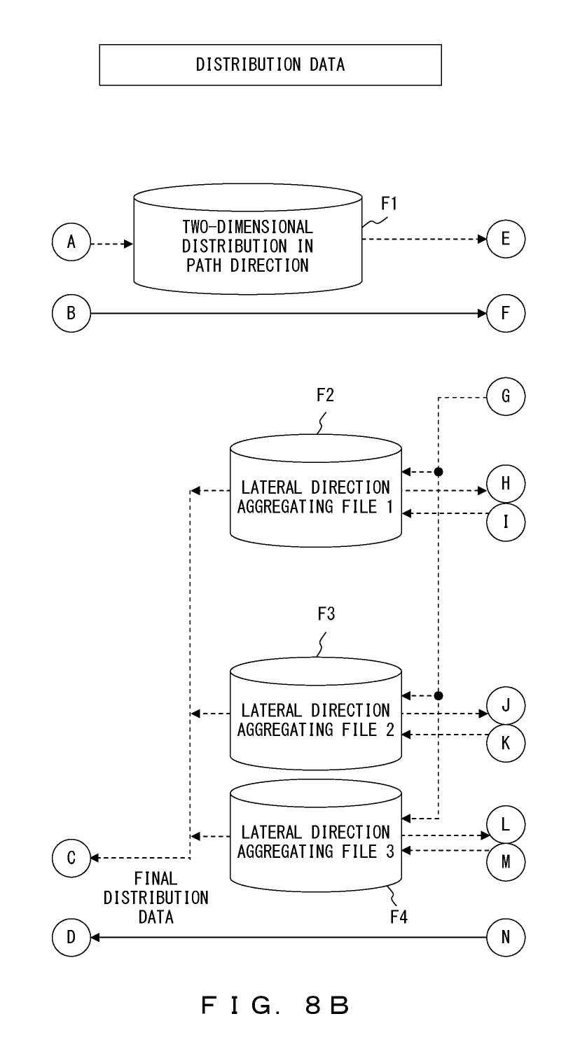

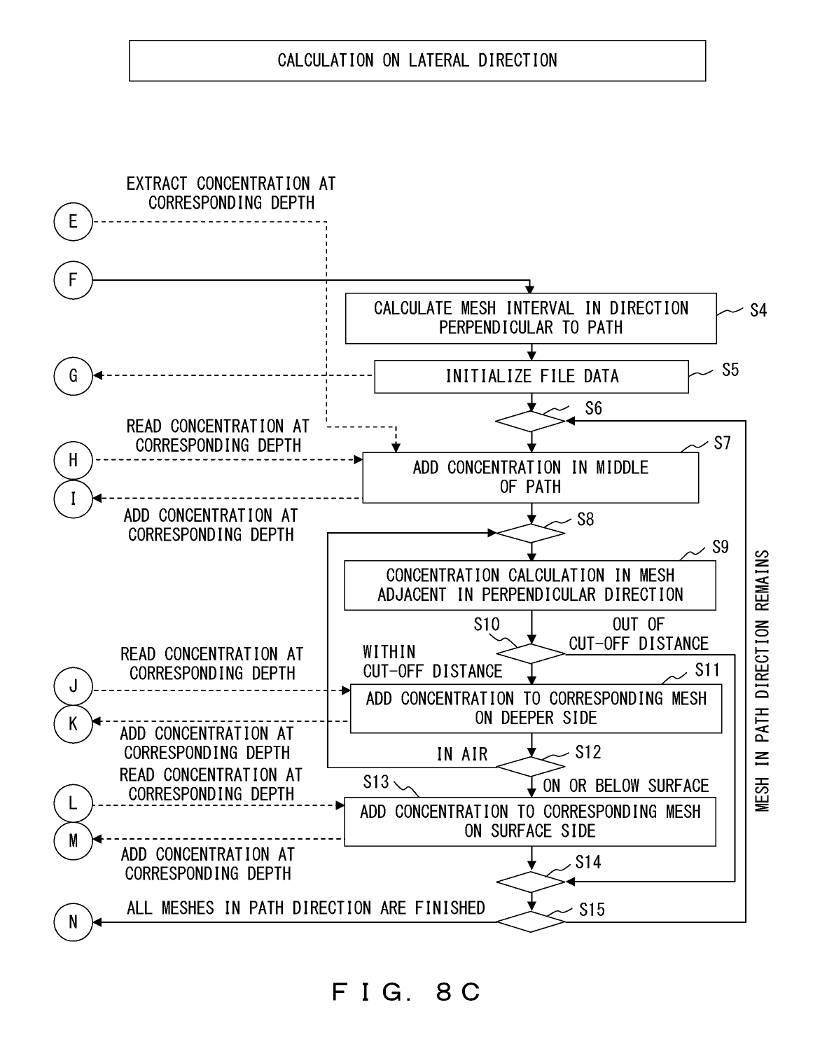

FIGS. 8A to 8C are flowcharts for performing the calculation of ion concentration distributions on the basis of a method of calculating ion concentration distributions according to an embodiment of the invention. In the flowchart in FIG. 8A, meshes in the implantation path direction are generated in a simulator (not illustrated) in step S1.

In step S2, the concentration distributions in the implantation path direction are calculated using the simulator. In other words, the simulator (not illustrated) obtains information (not illustrated) on the substrate, the impurities, the energy, the dose amount, and the like from the ion implantation condition, generates distribution data by executing prescribed simulation with reference to a database (not illustrated), and stores the two-dimensional distributions in the path direction as distribution data in file F1.

In step S3, it is determined whether or not the implantation condition includes tilted implantation, and when it does not include tilted implantation, the process proceeds to step S17 in FIG. 8A, and the concentration calculation is terminated, while when it does include tilted implantation, the process proceeds to step S4 in FIG. 8C, and the mesh interval in the direction perpendicular to the path direction is calculated in step S4. In other words, similarly to FIG. 7, the ion concentration distributions are calculated in FIG. 8 on the basis of the meshes defined in the embodiment along a beam that is being focused on.

In step S5, data in aggregating files F2 through F4 is cleared, and the files are initialized in order to store a result of an addition of concentration at the corresponding depth in the lateral direction. In step S6, it is confirmed that the mesh is the one related to the concentration calculation in the path direction. Then, in step S7, the concentration in the middle of the path is added. Upon this addition being made, the concentration at the corresponding depth is extracted from file F1, and the concentration at the corresponding depth is read out from aggregating file F2. Thereafter, the concentration in the middle of the path is added, and an addition of the concentration at the corresponding depth is performed, and the result is stored in aggregating file F2.

Next, in step S8, it is confirmed whether or not a mesh is in the air, and the process proceeds to step S9. In step S9, the calculation of the concentration is directed to the adjacent mesh which is adjacent in a direction perpendicular to the path direction. In step S10, it is confirmed whether or not the adjacent mesh is within the cut-off distance, and the process proceeds to step S11 if the adjacent mesh is within the cut-off distance.

In step S11, an addition of the concentration for the corresponding mesh in the deeper side is performed. This will be explained using the diagram illustrated in FIG. 7; specifically, the concentration is added in the mesh in the upper half, which is above the focused-on beam 3. Upon this addition of the concentration, the concentration in the lateral direction at the corresponding depth is read out from aggregating file F3. When the addition of the concentration to the mesh on the deeper side is finished, the concentration addition at the corresponding depth is performed, and the result is stored in aggregating file F3.

In step S12, it is determined whether or not the target mesh is on or below the surface, or is in the air, and when it is on or below the surface, the process proceeds to step S13. In step S13, an addition of the concentration to the corresponding mesh on the surface side is performed. This will be explained in the diagram illustrated in FIG. 7; specifically, the concentration is added in the mesh in the lower half, which is lower than the focused-on beam 3. Upon this addition of the concentration, the concentration in the lateral direction at the corresponding depth is read out from the aggregating file F4. When the addition of the concentration to the corresponding mesh on the surface side is finished, the concentration addition at the corresponding depth is performed, and the result is stored in aggregating file F4.

Next, the process proceeds to step S15 after undergoing step S14. When the concentration calculations for all the meshes in the path direction have not been finished in step S15, the process returns to step S6, and the processes in and after step S7 are executed. When the concentration calculations for all the meshes in the path direction have been finished, the process proceeds to step S16 in FIG. 8A.

In step S16 of FIG. 8A, the final concentration distribution data (including the concentration distribution data in the path direction obtained in step S7) stored in the lateral direction aggregating files F2 through F4 is obtained, and the path direction is converted into depth (i.e., converted into distance from the substrate surface), and the result is output, and thereafter the process of calculating the ion concentration distributions using the simulator is terminated after undergoing step S17.

When the mesh is out of the scope of the cut-off distance in step S10 in FIG. 8C, the process proceeds to step S15 after undergoing step S14. When the mesh does not exist on or below the surface but does exist in the air in step S12, the process returns to step S8, thereby skipping the process in step S13.

In addition, in FIG. 7, the concentration distributions are equivalently arranged at mesh positions spaced at intervals d/sinα on a plane parallel to the substrate surface 40, and these are consolidated to be added together so that the concentration distributions N(S₀) through N(S₆) may be obtained and so that all the concentration distributions, as well as the two-dimensional distributions in the path direction of the focused-on beam 3, may be obtained from the focused-on beam 3.

In such a case, the distribution of in the lateral direction with respect to the linear beam may be obtained in a manner in which concentration distributions at respective mesh points are sequentially obtained from one mesh point to another one adjacent thereto, wherein mesh points are arranged at prescribed intervals. In other words, what is meant by obtaining only the concentrations at a mesh point and at the adjacent mesh point when the concentration distribution is to be obtained by integration, is that the concentration distribution is obtained on the basis of representative values.

This means that the average value is obtained as the representative value by linearly approximating between each point and the adjacent point which are distant from each other by the mesh interval d/sinα and that integration is performed by using the thus obtained respective average values. However, the linear approximation does not always guarantee the providing of correct distributions, and thus when the distribution in the lateral direction with respect to the linear beam may be approximated by using a Gaussian function, an error function, which is an integral function thereof, may be used for the integration, and accordingly the concentrations of respective points may be calculated sequentially using the error function.

When this idea is expanded so that an arbitrary function is used for the distribution in the lateral direction with respect to the linear beam, an integral function thereof is calculated beforehand with finer meshes and the values of the integral function are used, and thereby the concentrations at respective points may be calculated. As an arbitrary function, functions widely used for the implantation distribution analysis, such as a joined half-Gaussian function, a general Tail function, a Pearson IV function, etc., may be used.

Although calculation processes that use a simulator for calculating ion concentration distributions have been explained above, this may be applied to the manufacturing of semiconductors performed by semiconductor manufacturing devices; in other words, to the control of the implantation of ions into semiconductor substrates.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A method of calculating anion concentration distribution, comprising:
setting meshes at regular intervals d along a beam axis of a beam implanted at a tilt angle α;
making mesh intervals on a surface d/sinα;
generating meshes parallel and perpendicular to the beam axis in a simulator; and
calculating an ion concentration distribution by using the meshes.

2. The method according to claim 1, further comprising:
focusing on one linear beam;
calculating a two-dimensional distribution in a path direction of the linear beam;
adding together concentrations at points on the meshes at substantially a same depth in a direction perpendicular to the surface; and
obtaining a value resultant from the adding as a concentration at the depth.

3. The method according to claim 2, wherein:
information on an upper half with respect to the linear beam is used to determine a concentration within a lower half.

4. The method according to claim 1, further comprising:
assuming that a distribution in a lateral direction with respect to the linear beam is expressed by a Gaussian function; and
using an error function that is an integral function of the Gaussian function to calculate a concentration at a point.

5. The method according to claim 1, further comprising:
assuming that a distribution in a lateral direction with respect to the linear beam is expressed by an arbitrary function;
calculating an integral function of the arbitrary function beforehand using secondary meshes finer than the meshes; and
calculating a concentration at a point using a value of the integral function.

6. The method according to claim 5, wherein:
the arbitrary function is either a joined half-Gaussian function, a general Tail function, or a Pearson IV function.

7. A computer-readable storage medium storing a program to instruct a computer to perform a process for calculating a concentration distribution of ions implanted at a tilt angle, the process comprising:
generating meshes in an implantation path direction;
calculating a two-dimensional distribution in the implantation path direction;
calculating a mesh interval in a direction perpendicular to the implantation path direction;
extracting a concentration at a corresponding depth from data of the two-dimensional distribution;
reading concentration data in a lateral direction at the corresponding depth;
adding concentration data in a middle of the path;
accumulating a resultant value as concentration data in the middle of the path at the corresponding depth;
adding a concentration to a corresponding mesh on a deeper side, and accumulating a resultant value as concentration data in the lateral direction at a corresponding depth on the deeper side to calculate a concentration of a mesh adjacent in a direction perpendicular to the implantation path direction;
adding a concentration to a corresponding mesh on a surface side, and accumulating a resultant value as concentration data in the lateral direction at a corresponding depth on the surface side to calculate a concentration of a mesh adjacent in the direction perpendicular to the implantation path direction;
obtaining the concentration data in the middle of the path and the concentration data in the lateral direction on the deeper side and on the surface side that are accumulated; and
converting the path direction into a depth so that all concentration data is calculated when additions of concentrations in all corresponding meshes in the implantation path direction are terminated.

8. The computer-readable storage medium according to claim 7, wherein:
the process further includes skipping the accumulating the resultant value as the concentration data in the lateral direction at the corresponding depth on the surface side when the corresponding mesh is in an air.
